(19) United States
(12) Patent Application Publication
(10) Pub. No.: US 2015/0215260 A1
(43) Pub. Date: Jul. 30, 2015

(54) METHOD FOR GUARANTEEING COMMUNICATION LIABILITY

(71) Applicant: Ping Ha, Hong Kong (CN)

(72) Inventor: Ping Ha, Hong Kong (CN)

(21) Appl. No.: 14/392,000

(22) PCT Filed: Apr. 11, 2012
(86) PCT No.: PCT/CN2012/073775

§ 371 Date: Apr. 2, 2015

(51) Int. Cl. H04L 12/58; G06Q 10/10; H04L 29/08

(52) U.S. Cl. CPC H04L 51/30; H04L 67/10; H04L 51/34; G06Q 10/107

(57) ABSTRACT

The present invention discloses a method for guaranteeing communication reliability, comprising: issuing different levels of electronic stamps; and allowing an electronic mail with the electronic stamp to obtain a service corresponding to the level of the electronic stamp. By using the present invention can the reliability of communication be guaranteed, and the deep-level communication demand of a correspondent be satisfied.

### TECHNICAL FIELD

The present invention relates to the field of communications, in particular to communication technologies of electronic emails via the Internet.

### BACKGROUND

Traditional mails are communicated via post offices as the intermediaries, and the mails are delivered in a sequence including a plurality of steps such as collecting, sorting and dispatching, transporting and delivering, etc. The main way of collection is to arrange mailboxes, pillar-boxes and business windows at the post offices for direct collection. As for sorting and dispatching, the mails are sorted according to the destinations, and then the sorted mails are respectively encapsulated into bulk mails for dispatch. As for transporting, the bulk mails are respectively transported to the destinations via specified postal routes. Undeliverable mails are generally returned to the addressers.

In the information age, the Internet-mediated communication modes have been fully developed, and in particular the use of electronic mails is gradually gaining popularity. An electronic mail is a communication mode of providing information exchange using electronic means, and is an Internet service which is most widely used. Users can contact network users in any corner of the world at a very low price and in a very fast manner through the electronic mail system of the network. These electronic mails may include various contents, such as texts, images, sounds, etc.

However, either the traditional mails or the electronic mails can only satisfy people's relatively basic demand of communication, i.e., delivering the contents sent by a user to a region where a target object can receive the contents. However, such communication is still unreliable. In specific, it cannot be guaranteed as to whether the target object will read the contents of the communication. Furthermore, more importantly, it cannot be guaranteed either as to whether the purposes of communication, e.g., the requests reflected in the mails, can be satisfied.

### SUMMARY OF THE INVENTION

With respect to the abovementioned problems, the present invention provides a method for guaranteeing communication reliability, comprising: issuing different levels of electronic stamps; and allowing an electronic mail with the electronic stamp to obtain a service corresponding to the level of the electronic stamp, wherein the electronic mail is stored on a mail server after having been subjected to automatic detection and encryption, and a receiver of the electronic mail accesses the electronic mail via a unique code of the received electronic mail and an address link stored in the electronic mail.

According to one aspect of the present invention, there is provided a method for guaranteeing communication reliability, wherein the service includes an addressee of the electronic mail replying to the electronic mail or responding to contents of the electronic mail.

According to one aspect of the present invention, there is provided a method for guaranteeing communication reliability, wherein the electronic stamp is displayed as a picture showing “Mission Will Be Accomplished”.

According to one aspect of the present invention, there is provided a method for guaranteeing communication reliability, wherein the picture of the electronic stamp has thereon a price corresponding to the level thereof.

According to one aspect of the present invention, there is provided a method for guaranteeing communication reliability, wherein the electronic stamp is a file in a specific format.

According to one aspect of the present invention, there is provided a method for guaranteeing communication reliability, wherein mail status parameters for a sender of the electronic mail to know a status of the electronic mail are contained in the electronic mail.

The present invention further provides a method for reliable communication, comprising: purchasing an electronic stamp from an issuer of the electronic stamp through a particular purchase channel; and attaching the electronic stamp when an electronic mail is sent to an addressee of the electronic mail, a level of the attached electronic stamp corresponding to a desired service, wherein the electronic mail is stored on a mail server after having been subjected to automatic detection and encryption, and a receiver of the electronic mail accesses the electronic mail via a unique code of the received electronic mail and an address link stored in the electronic mail.

According to one aspect of the present invention, there is provided a method for reliable communication, wherein the service includes the addressee of the electronic mail replying to the electronic mail or responding to contents of the electronic mail.

According to one aspect of the present invention, there is provided a method for reliable communication, wherein the electronic stamp is displayed as a picture showing “Mission Will Be Accomplished”.

According to one aspect of the present invention, there is provided a method for reliable communication, wherein the picture of the electronic stamp has thereon a price corresponding to the level thereof.

According to one aspect of the present invention, there is provided a method for reliable communication, wherein the electronic stamp is a file in a specific format.

According to one aspect of the present invention, there is provided a method for reliable communication, wherein mail status parameters for a sender of the electronic mail to know a status of the electronic mail are contained in the electronic mail.

By using the present invention can the high reliability in communication between an addresser and an addressee of an electronic mail be guaranteed.

### BRIEF DESCRIPTION OF THE DRAWINGS

The present invention can be understood more comprehensively by reading the following detailed description with reference to the drawings. In the drawings:

FIG. 1 shows a flow chart according to one embodiment of the present invention;

FIG. 2 shows a flow chart according to another embodiment of the present invention.

### DETAILED DESCRIPTION OF EMBODIMENTS

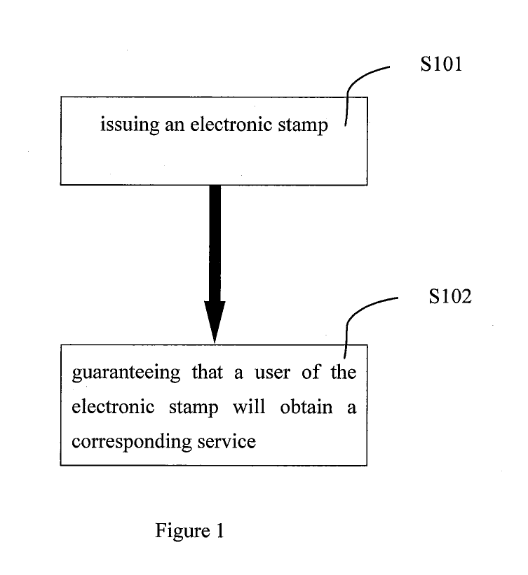

In one embodiment of the present invention, an issuer of electronic stamps invites target objects to join a specific organization to become members and issue the electronic stamps (Step S101 in FIG. 1). The members of the specific organization respect the rights of the electronic stamps, and agree to give correspondingly different responses according to the levels of the electronic stamps upon receiving the electronic mails attached with the electronic stamps issued by the organization. Having made the responses, the specific organization correspondingly rewards the members.

The electronic stamps may be files in a specific format, and/or may have eye-catching file icons. As an example, the central areas of the icons of the electronic stamps are texts showing the service slogans thereof, e.g., “Mission Will Be Accomplished”. The electronic stamps may have different levels which can be distinguished by the patterns of the file icons thereof or, in particular, by the par values directly indicated on the patterns. For example, the electronic stamps can be divided into platinum electronic stamps, red gold electronic stamps and black gold electronic stamps, whose par values are 80 yuan, 800 yuan and 8000 yuan, respectively. The electronic stamps with different par values represent different service contents. For example, the platinum stamps indicate that, if the electronic stamps are used to send electronic mails, the addressees will respond and will open the electronic mails for sure; the red gold electronic stamps indicate that, if the electronic stamps are used to send electronic mails, the addressees will respond and will download the electronic mails for sure; the black gold electronic stamps indicate that, if the electronic stamps are used to send electronic mails, the addressees will respond in depth and will reply to the electronic mails for sure. The service contents offered by different electronic stamps will be regulated by terms of service for the electronic stamps formulated by the issuer of the electronic stamps. The issuer is entitled to update and make amendments.

As an example, let the organization be named “Leader Membership”. The members having the “Leader Membership” are invited to join the organization by the website of “Chinese Entrepreneurial Leaders” and are not required to pay the fees. After a person has become a member of “Chinese Entrepreneurial Leaders”, the website of “Chinese Entrepreneurial Leaders” allocates a unique membership number to the member, and opens a personal account for the member.

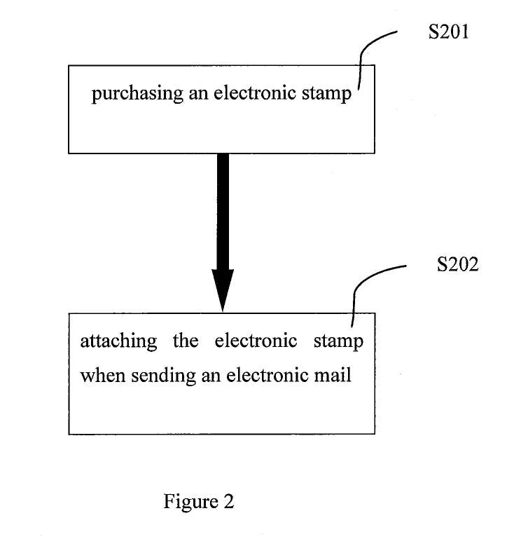

The members should observe the terms of service for the electronic stamps. For example, a movie star Mr. A is invited to become a member. If a movie fan X purchases a red gold electronic stamp (Step S201 in FIG. 2) and attaches the red gold electronic stamp to an electronic mail addressed to Mr. A (Step S202 in FIG. 2), A is requested in the letter to reply to the mail and present a picture of an electronic poster. If it is specified in the terms of service for the electronic stamps that such requests should be satisfied for the letters attached with the red gold electronic stamps, then A should download the mail and have the opportunity to reply to the mail and attach the electronic poster (Step S102 in FIG. 1). In return, the issuer of the electronic stamp transfers part of the payment made by the movie fan X for purchasing the red gold electronic stamp to Mr. A's personal account.

For another example, an entrepreneur Mr. B is invited to become a member. If Mr. B receives a letter attached with a black gold electronic stamp and sent by an entrepreneur Y, Mr. B is requested in the letter to reply to the mail and provide advice to a business proposal attached to Y's letter. If it is specified in the terms of service for the electronic stamps that such requests should be satisfied for the letters attached with the black gold electronic stamps, then B should reply to the mail and comment on the attached contents. In return, the issuer of the electronic stamp transfers part of the payment made by the entrepreneur Y for purchasing the black gold electronic stamp to the entrepreneur Mr. B's personal account or offers a donation payment to a charitable organization in the name of Mr. B according to Mr. B's requirements.

When a customer sends an electronic mail with the abovementioned electronic stamps, the system will perform automatic detection to ensure that the electronic mail is a mail containing nothing hazardous. The hazards herein might involve a plurality of aspects, for example, the mail might contain viruses, or the contents of the mail is threatening. Therefore, automatic detection may include means of using anti-virus software for scanning and anti-virus, and keyword scanning or manual troubleshooting to eliminate these threats.

Having passed the automatic detection, the system encrypts the electronic mail according to a password of a target receiver of the electronic mail, and the encrypted electronic mail can only be decrypted by the password. The encrypted electronic mail is stored in an electronic mail server, a background program attaches a unique number to the electronic stamp, and then the system sends the electronic mail including an electronic mail address in the electronic mail server and the unique number to the electronic mail receiver.

The electronic mail received by the receiver is not an original electronic mail directly sent by the customer, but a notification mail including a unique number and an address link of the original electronic mail in the electronic mail server. Via the address link in the notification mail can the receiver access the electronic mail server, and then log onto the system to view, download and reply to the original electronic mail according to the unique number in the notification mail and the receiver's own registration password in the electronic mail system.

Mail status parameters are inserted in each electronic mail for the server to track each electronic mail. Starting from the receiver's opening of the electronic mail, the server tracks the mail according to the mail status parameters that return automatically, and saves them in the database. Each status can be shown to the sender to learn more, so the sender can accurately and quickly know the status of each mail.

Although the preferred embodiments of the present invention have been introduced in the drawings and the preceding detailed description, it should be understood that the present invention is not limited to the specifically published embodiments, and can still have various modifications and variations without departing from the scope specified in the claims.

1. A method for guaranteeing communication reliability, comprising:
issuing different levels of electronic stamps; and
allowing an electronic mail with the electronic stamp to obtain a service corresponding to the level of the electronic stamp, wherein the electronic mail is stored on a mail server after having been subjected to automatic detection and encryption, and a receiver of the electronic mail accesses the electronic mail via a unique code of the received electronic mail and an address link stored in the electronic mail.

2. The method for guaranteeing communication reliability according to claim 1, wherein the service includes an addressee of the electronic mail replying to the electronic mail or responding to contents of the electronic mail.

3. The method for guaranteeing communication reliability according to claim 1 or 2, wherein the electronic stamp is displayed as a picture showing “Mission Will Be Accomplished”.

4. The method for guaranteeing communication reliability according to claim 1 or 2, wherein the picture of the electronic stamp has thereon a price corresponding to the level thereof.

5. The method for guaranteeing communication reliability according to claim 1 or 2, wherein the electronic stamp is a file in a specific format.

6. The method for guaranteeing communication reliability according to claim 1, wherein mail status parameters for a sender of the electronic mail to know a status of the electronic mail are contained in the electronic mail.

7. A method for reliable communication, comprising:
purchasing an electronic stamp from an issuer of an electronic stamp through a particular purchase channel; and
attaching the electronic stamp when an electronic mail is sent to an addressee of the electronic mail, a level of the attached electronic stamp corresponding to a desired service, wherein the electronic mail is stored on a mail server after having been subjected to automatic detection and encryption, and a receiver of the electronic mail accesses the electronic mail via a unique code of the received electronic mail and an address link stored in the electronic mail.

8. The method for reliable communication according to claim 7, wherein the service includes the addressee of the electronic mail replying to the electronic mail or responding to contents of the electronic mail.

9. The method for reliable communication according to claim 7 or 8, wherein the electronic stamp is displayed as a picture showing “Mission Will Be Accomplished”.

10. The method for reliable communication according to claim 7 or 8, wherein the picture of the electronic stamp has thereon a price corresponding to the level thereof.

11. The method for reliable communication according to claim 7 or 8, wherein the electronic stamp is a file in a specific format.

12. The method for guaranteeing communication reliability according to claim 7, wherein mail status parameters for a sender of the electronic mail to know a status of the electronic mail are contained in the electronic mail.
